(19) United States
(12) Patent Application Publication
(10) Pub. No.: US 2025/0301424 A1
(43) Pub. Date: Sep. 25, 2025

(54) SYNCHRONIZATION SIGNAL TRANSMISSION METHOD AND APPARATUS, TERMINAL, AND NETWORK-SIDE DEVICE

(71) Applicant: VIVO MOBILE COMMUNICATION CO., LTD., Dongguan (CN)

(72) Inventors: Pengfei WANG, Dongguan (CN); Kun YANG, Dongguan (CN); Dajie JIANG, Dongguan (CN)

(21) Appl. No.: 19/227,692

(22) Filed: Jun. 4, 2025

Related U.S. Application Data
(63) Continuation of application No. PCT/CN2023/135396, filed on Nov. 30, 2023.

(30) Foreign Application Priority Data
Dec. 6, 2022 (CN) 202211559195.4

(51) Int. Cl. H04W 56/00

(52) U.S. Cl. CPC H04W 56/00

(57) ABSTRACT

A synchronization signal transmission method includes: receiving, by a terminal, a first synchronization signal sent by a network-side device; and obtaining signal quality of the first synchronization signal; and determining, by the terminal based on the signal quality, whether to detect a second synchronization signal. The signal quality includes at least one of the following: Reference Signal Received Power (RSRP); Reference Signal Received Quality (RSRQ); or a Signal to Interference plus Noise Ratio (SINR).

### CROSS-REFERENCE TO RELATED APPLICATIONS

This application is a bypass continuationn of International Application No. PCT/CN2023/135396, filed on Nov. 30, 2023, which claims the benefit of and priority to Chinese Patent Application No. 202211559195.4 filed on Dec. 6, 2022, the contents of both of which being incorporated by reference in their entireties herein.

### TECHNICAL FIELD

This application relates to the field of communication technologies, and in particular, to a synchronization signal transmission method and apparatus, a terminal, and a network-side device.

### BACKGROUND

In a Cell-Free network, the density of Transmission Reception Points (TRPs) can be extremely high, while the available synchronization signal resources remain limited. As the number of TRPs increases, the network may need to reduce the size of each cell to allow reuse of the same synchronization signal resources across different cells. However, this approach introduces two key challenges.

First, increased cell densification leads to greater interference between synchronization signals from neighboring cells. Second, the continuous deployment of new, smaller cells to accommodate more TRPs increases the overall complexity of network deployment.

### BRIEF SUMMARY

According to a first aspect, a synchronization signal transmission method is provided. The method includes:
receiving, by a terminal, a first synchronization signal sent by a network-side device; and obtaining signal quality of the first synchronization signal; and
determining, by the terminal based on the signal quality, whether to detect a second synchronization signal, where
the signal quality includes at least one of the following:

Reference Signal Received Power (RSRP);

### Reference Signal Received Quality (RSRQ); or

Signal to Interference plus Noise Ratio (SINR).

According to a second aspect, a synchronization signal transmission apparatus is provided, used in a terminal. The apparatus includes:
a first receiving module, configured to receive a first synchronization signal sent by a network-side device; and obtain signal quality of the first synchronization signal; and
a first determining module, configured to determine, based on the signal quality, whether to detect a second synchronization signal, where
the signal quality includes at least one of the following:

Reference Signal Received Power (RSRP);
Reference Signal Received Quality (RSRQ); or
a Signal to Interference plus Noise Ratio (SINR).

According to a third aspect, a synchronization signal transmission method is provided. The method includes:

sending, by a network-side device, a first synchronization signal and a second synchronization signal.

According to a fourth aspect, a synchronization signal transmission apparatus is provided, used in a network-side device. The apparatus includes:

a first sending module, configured to send a first synchronization signal and a second synchronization signal.

According to a fifth aspect, a terminal is provided, including a processor and a memory. The memory stores a program or instructions that can be run on the processor, and when the program or the instructions are executed by the processor, steps of the method according to the first aspect are implemented.

According to a sixth aspect, a terminal is provided, including a processor and a communication interface. The communication interface is configured to receive a first synchronization signal sent by a network-side device; and obtain signal quality of the first synchronization signal; and the processor is configured to determine, based on the signal quality, whether to detect a second synchronization signal, where the signal quality includes at least one of the following:
Reference Signal Received Power (RSRP);
Reference Signal Received Quality (RSRQ); or
a Signal to Interference plus Noise Ratio (SINR).

According to a seventh aspect, a network-side device is provided, including a processor and a memory. The memory stores a program or instructions that can be run on the processor, and when the program or the instructions are executed by the processor, steps of the method according to the third aspect are implemented.

According to an eighth aspect, a network-side device is provided, including a processor and a communication interface. The communication interface is configured to send a first synchronization signal and a second synchronization signal.

According to a ninth aspect, a synchronization signal transmission system is provided, including: a terminal and a network-side device, where the terminal may be configured to perform steps of the method according to the first aspect, and the network-side device may be configured to perform steps of the method according to the third aspect.

According to a tenth aspect, a readable storage medium is provided. The readable storage medium stores a program or instructions, and when the program or the instructions are executed by a processor, steps of the method according to the first aspect or the third aspect are implemented.

According to an eleventh aspect, a chip is provided. The chip includes a processor and a communication interface. The communication interface is coupled with the processor, and the processor is configured to run a program or instructions, to implement steps of the method according to the first aspect or the third aspect.

According to a twelfth aspect, a computer program/program product is provided. The computer program/program product is stored in a storage medium. The computer program/program product is executed by at least one processor to implement steps of the method according to the first aspect or the third aspect.

### BRIEF DESCRIPTION OF THE DRAWINGS

FIG. 1 is a block diagram of a wireless communication system to which an embodiment of this application is applicable;

FIG. 2 is a diagram of a structure of an NR SSB;

FIG. 3 is a diagram of PBCH composition;

FIG. 4 is a schematic flowchart 1 of a synchronization signal transmission method according to an embodiment of this application;

FIG. 5 is a diagram of a time domain relationship between two stages of synchronization signals;

FIG. 6 is a diagram of frequency division of a second-stage synchronization signal;

FIG. 7 is a diagram of time division of a second-stage synchronization signal;

FIG. 8 is a diagram of a structure of a second-stage synchronization signal;

FIG. 9 is a schematic flowchart 2 of a synchronization signal transmission method according to an embodiment of this application;

FIG. 10 is a diagram 1 of modules of a synchronization signal transmission apparatus according to an embodiment of this application;

FIG. 11 is a diagram of a structure of a terminal according to an embodiment of this application;

FIG. 12 is a diagram 2 of modules of a synchronization signal transmission apparatus according to an embodiment of this application;

FIG. 13 is a diagram of a structure of a network-side device according to an embodiment of this application; and

FIG. 14 is a diagram of a structure of a communication device according to an embodiment of this application.

### DETAILED DESCRIPTION

The following describes the technical solutions in embodiments of this application with reference to the accompanying drawings in embodiments of this application. It is clear that the described embodiments are some, but not all, of embodiments of this application. All other embodiments obtained by a person of ordinary skill in the art based on embodiments of this application fall within the protection scope of this application.

In the specification and claims of this application, the terms “first”, “second”, and the like are intended to distinguish similar objects, but are not necessarily used to describe a specific order or sequence. It should be understood that terms used in such a way are interchangeable in proper circumstances, so that embodiments of this application described herein can be implemented in an order different from the order illustrated or described herein. In addition, the objects distinguished by “first” and “second” are usually one category, and a quantity of objects is not limited. For example, the first object may be one or more. In addition, the term “and/or” used in this specification and the claims represents at least one of connected objects. The character “/” usually indicates an “or” relationship between associated objects.

It is worth noting that, the technology described in embodiments of this application is not limited to being used in a Long-Term Evolution (LTE)/LTE-Advanced (LTE-A) system, but may be used in another wireless communication system, for example, a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single carrier-Frequency Division Multiple Access (SC-FDMA) system, and another system. The terms “system” and “network” are often interchangeably used in embodiments of this application, and the technology described may be used for both the system and radio technology mentioned above, and used for another system and radio technology. The following description describes a New Radio (NR) system for purposes of example, and the term of NR is used in most of the descriptions below, but these technologies are also applicable to an application beyond an NR system application, for example, a 6th Generation (6G) communication system.

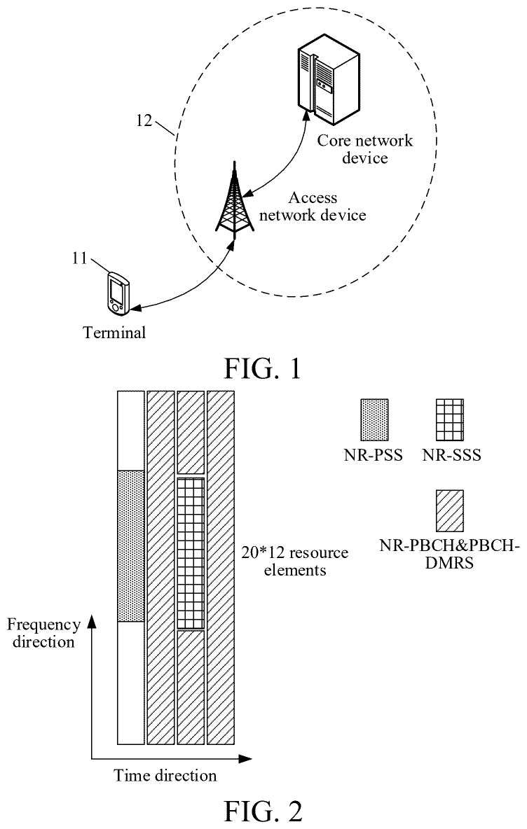

FIG. 1 is a block diagram of a wireless communication system to which an embodiment of this application is applicable. The wireless communication system includes a terminal 11 and a network-side device 12. The terminal 11 may be a mobile phone, a tablet computer (Tablet Personal Computer), a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a Vehicle User Equipment (VUE), a Pedestrian User Equipment (PUE), a smart home (home devices with a wireless communication function, such as a refrigerator, a television, a washing machine, or furniture), a game console, a Personal Computer (PC), a teller machine, a self-service machine, a sensing service terminal, various sensors, a smart camera, another terminal-side device, or the like. The wearable device includes: a smart watch, a smart band, smart headphones, smart glasses, smart jewelry (a smart bangle, a smart bracelet, a smart ring, a smart necklace, a smart ankle bracelet, a smart anklet, and the like), a smart wristband, smart clothing, and the like. It should be noted that, a specific type of the terminal 11 is not limited in embodiments of this application. The network-side device 12 may include an access network device or a core network device. The access network device may alternatively be referred to as a radio access network device, a Radio Access Network (RAN), a radio access network function, or a radio access network element. The access network device may include a base station, a Wireless Local Area Network (WLAN) access point, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), a sensing signal sending device, a sensing signal receiving device, or another proper term in the art. As long as the same technical effect is achieved, the base station is not limited to a specific technical vocabulary. It should be noted that, only a base station in an NR system is used as an example in embodiments of this application, and a specific type of the base station is not limited. A core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), a Centralized Network Configuration (CNC), a Network Repository Function (NRF), a Network Exposure Function (NEF), a Local NEF (or an L-NEF), a Binding Support Function (BSF), an Application Function (AF), or the like.

The technology related to embodiments of this application are first described below.

### 1. Cell-Free Massive Multiple-In Multiple-Out (MIMO) System

The cell-free massive MIMO system may be considered as deconstruction of a conventional massive MIMO system. Antennas in the conventional massive MIMO system are intensively distributed at one site (base station), and User Equipment (UE) is distributed around the base station in a form of a cell. In a massive MIMO system, a large quantity of antennas are deployed on each base station. Therefore, a high array gain and high spatial resolution are provided. A plurality of UEs may be simultaneously served on the same time-frequency resources, so that a high throughput, high reliability, and high energy efficiency are provided. There is no cell in the cell-free massive MIMO system, and a large quantity of antennas are dispersedly distributed in wide domain, and the UEs are also dispersedly distributed in the wide domain. The antennas are referred to as transmission reception points TRPs or Access Points (APs). Theoretically, each UE can communicate with each AP. Through a fronthaul network and a Central Processing Unit (CPU), a large quantity of geographically dispersed TRPs can serve a small quantity of UEs, and the CPU performs joint detection by using channel statistics information. A cell-free massive MIMO network is expected to be used in a next-generation indoor scenario with hotspot coverage, for example, an intelligent factory, a train station, a shopping center, a stadium, a subway, a hospital, a community center, or a university campus.

### 2. Cell Search and Synchronization Procedure in 5th Generation (5G) NR Technology

In the existing 5G NR technology, to implement downlink synchronization, UE needs to search for a synchronization signal/physical broadcast channel block (Synchronization Signal Physical Broadcast Channel Block, SS/PBCH Block or SSB), to obtain a frequency of an access carrier. Because a spectrum range of the NR is wide, to reduce search complexity, the UE performs an SSB search based on a specific frequency interval stipulated by a protocol. The frequency interval is referred to as a Synchronization Raster. The UE detects reference signal received power of a synchronization signal (Synchronization Signal Reference Signal Received Power, SS-RSRP) on a corresponding frequency based on the synchronization raster, and selects an appropriate SSB based on a threshold (rsrp-ThresholdSSB) configured by a network. That is, if there is an SSB with signal quality SS-RSRP greater than a threshold, the SSB that satisfies a condition is selected; if there is a plurality of SSBs that satisfies the condition, an SSB is selected (the selection is decided and implemented by the terminal); or if there is no SSB that satisfies the condition, an SSB is selected from an entire SSB set (the selection is decided and implemented by the terminal). The UE determines, based on an association relationship between an SSB and a Random Access Channel occasion (RO), an RO resource set and a preamble resource set that are associated with the SSB. The UE randomly selects one RO resource and one preamble resource from the resource set, sends a message 1 (Msg 1), and initiates a random access procedure.

### 3. Structure of SSB in 5G NR Technology

an initial search process is completed by using the SSB. The SSB includes a Primary Synchronization Signal (PSS), a Secondary Synchronization Signal (SSS), a Physical Broadcast Channel (PBCH), and a Demodulation Reference Signal (DMRS) received within four consecutive Orthogonal Frequency-Division Multiplexing (OFDM) symbols, and is mainly used for downlink synchronization. A structure of the SSB is shown in FIG. 2.

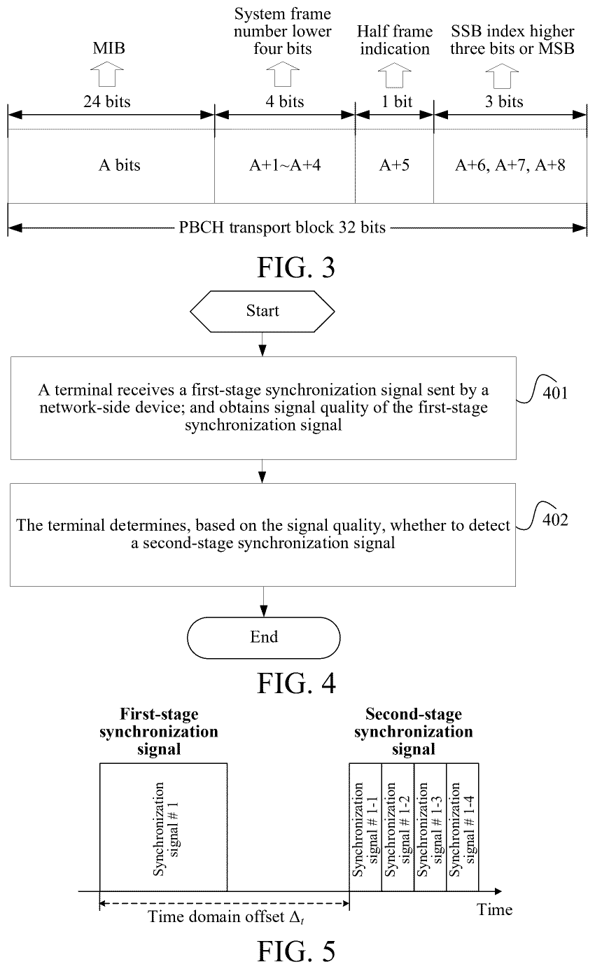

The SSB includes: a PSS, an SSS, a PBCH, and a physical broadcast channel demodulation reference signal PBCH-DMRS. Main functions of the PSS and the SSS are to implement symbol synchronization and determine a Physical Cell Identity (PCI). As shown in FIG. 3, the PBCH includes a Master Information Block (MIB) of a cell, and some other information. The PBCH-DMRS is used as a PBCH demodulation reference signal, and includes some SSB-index information (higher three bits).

Embodiments of this application provide a synchronization signal transmission method and apparatus, a terminal, and a network-side device, to resolve a problem of mutual interference of synchronization signals in neighboring cells and high network deployment complexity, caused by the reuse of the same synchronization signal resources in different cells.

A synchronization signal transmission method and apparatus and a device according to embodiments of this application are described in detail below by using some embodiments and application scenarios thereof with reference to the accompanying drawings.

As shown in FIG. 4, an embodiment of this application provides a synchronization signal transmission method, including the following steps.

Step 401: A terminal receives a first-stage synchronization signal sent by a network-side device; and obtains signal quality of the first-stage synchronization signal.

Step 402: The terminal determines, based on the signal quality, whether to detect a second-stage synchronization signal.

The signal quality includes at least one of the following:
Reference Signal Received Power (RSRP);
Reference Signal Received Quality (RSRQ); or
a Signal to Interference plus Noise Ratio (SINR).

According to embodiments of this application, whether to detect the second-stage synchronization signal is determined based on the signal quality of the first-stage synchronization signal. By introducing two stages of synchronization signals, the mutual interference of synchronization signals in neighboring cells caused by the reuse of the same synchronization signal resources in different cells can be reduced, and the network deployment complexity can also be reduced.

It should be noted that, two stages of synchronization signals are set, and whether to detect the second-stage synchronization signal is determined based on the signal quality of the first-stage synchronization signal, so that network deployment complexity can be simplified, interference of synchronization signals can be reduced, and reliability of random access performed by the terminal can be improved.

Optionally, in another embodiment of this application, that the terminal determines, based on the signal quality, whether to detect the second-stage synchronization signal includes:

the terminal detects the second-stage synchronization signal in a case that the signal quality of the first-stage synchronization signal is less than a first threshold.

It should be noted that, the terminal detects the second-stage synchronization signal only when the signal quality of the first-stage synchronization signal is less than the first threshold, and does not detect the second-stage synchronization signal when the signal quality of the first-stage synchronization signal is greater than or equal to the first threshold. In this way, power consumption caused by detection of the second synchronization signal can be further reduced without affecting data transmission of the terminal.

Optionally, in another embodiment of this application, detecting the second-stage synchronization signal includes:
the terminal obtains a resource position of the second-stage synchronization signal based on a resource associated with the first-stage synchronization signal, where the resource position of the second-stage synchronization signal includes: a time domain position and/or a frequency domain position; and
the terminal detects the second-stage synchronization signal based on the resource position of the second-stage synchronization signal.

It should be noted that, the resource associated with the first-stage synchronization signal may carry a master information block MIB and/or a System Information Block (SIB) in a system message. Optionally, the resource associated with the first-stage synchronization signal may also carry a message carried by other Radio Resource Control (RRC) signaling (it should be noted that, a Quasi co-location (QCL) of the message carried by the other RRC signaling should be consistent with that of the first-stage synchronization signal).

Optionally, in another embodiment of this application, that the terminal obtains the resource position of the second-stage synchronization signal based on the resource associated with the first-stage synchronization signal includes:
the terminal obtains indication information on the resource associated with the first-stage synchronization signal, where the indication information includes: explicit information and/or implicit information indicating the resource position of the second-stage synchronization signal; and
the terminal determines, based on the indication information, the resource position of the second-stage synchronization signal.

Specifically, the explicit information includes at least one of the following:

A11: a synchronization raster (Sync raster) of the second-stage synchronization signal.

It should be noted that, a specific position of the synchronization raster (sync raster) of the second-stage synchronization signal may be obtained by the network-side device based on a position of a sync raster of the first-stage synchronization signal and a preset rule, and then the network-side device notifies the terminal of the position.

A12: a frequency domain position of the second-stage synchronization signal.

A13: a time domain position of the second-stage synchronization signal.

It may be understood that, the explicit information is direct indication information of the resource position of the second-stage synchronization signal. The implicit information is indirect indication information of the resource position of the second-stage synchronization signal, that is, the terminal needs to further obtain the resource position of the second synchronization signal based on the related information of the first-stage synchronization signal.

Specifically, the implicit information includes at least one of the following:

A21: a time domain offset and/or a frequency domain offset of the second-stage synchronization signal relative to the first-stage synchronization signal.

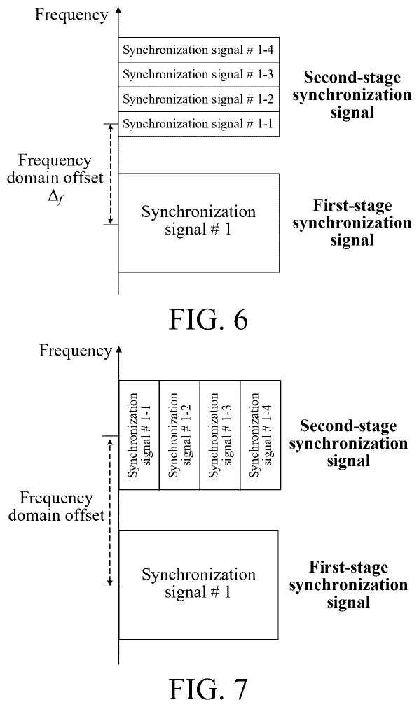

It should be noted that, in this case, the time domain offset and/or the frequency domain offset of the second-stage synchronization signal is indicated, and the terminal can obtain the time domain position and/or the frequency domain position of the second-stage synchronization signal based on the time domain position and/or the frequency domain position of the first-stage synchronization signal and the corresponding offset. That is, the time domain position and/or the frequency domain position of the second-stage synchronization signal may be determined based on the time domain position and/or the frequency domain position of the first-stage synchronization signal, and may be implemented by introducing a fixed time domain offset and/or a fixed frequency domain offset between the two stages of synchronization signals. As shown in FIG. 5, a time domain position of each second-stage synchronization signal may be indicated by the time domain offset Δₜ relative to the first-stage synchronization signal. As shown in FIG. 6 and FIG. 7, a frequency domain position of each second-stage synchronization signal may be indicated by the frequency domain offset Δf relative to the first-stage synchronization signal. Optionally, alternatively, both the time domain offset and the frequency domain offset may be provided. That is, a frequency domain position of each second-stage synchronization signal is indicated by the frequency domain offset relative to the first-stage synchronization signal, and a time domain position is indicated by the time domain offset relative to the first-stage synchronization signal. It should be further noted that, a time/frequency domain interval between the second-stage synchronization signals may be different from that of the first-stage synchronization signals. The second-stage synchronization signal may be used in time division or frequency division.

A22: a mapping relationship between an index set of the first-stage synchronization signal and an index set of the second-stage synchronization signal.

For example, the mapping relationship between the index set of the first-stage synchronization signal and the index set of the second-stage synchronization signal may be provided in Table 1.

TABLE 1
Mapping table of first-stage synchronization signal and second-stage
synchronization signal

| First-stage | |
|---|---|
| synchronization | Second-stage synchronization |
| signal | signal index set |
| Synchronization signal # 1 | Synchronization signal # 1-1, |
| | synchronization signal # 1-2, |
| | synchronization signal # 1-3, and |
| | synchronization signal # 1-4 |
| Synchronization signal # 2 | Synchronization signal # 2-1, |
| | synchronization signal # 2-2, |
| | synchronization signal # 2-3, and |
| | synchronization signal # 2-4 |
| Synchronization signal # 3 | Synchronization signal # 3-1, |
| | synchronization signal # 3-2, |
| | synchronization signal # 3-3, and |
| | synchronization signal # 3-4 |
| Synchronization signal # 4 | Synchronization signal # 4-1, |
| | synchronization signal # 4-2, |
| | synchronization signal # 4-3, and |
| | synchronization signal # 4-4 |

Further, it should be further noted that, in another embodiment of this application, in a case that the indication information includes the implicit information, that the terminal determines, based on the indication information, the resource position of the second-stage synchronization signal includes:

the terminal the resource position of the second-stage synchronization signal based on the indication information and the time domain position and/or the frequency domain position of the first-stage synchronization signal.

That is, if the network-side device only provides the implicit information of the resource position of the second-stage synchronization signal, the terminal further needs to determine the resource position of the second-stage synchronization signal based on the time domain position and/or the frequency domain position of the first-stage synchronization signal.

Optionally, in another embodiment of this application, the indication information further includes: configuration information, where the configuration information includes at least one of the following:

A31: a quantity of the second-stage synchronization signals.

A32: a time domain interval of the second-stage synchronization signals.

It should be noted that, the time domain interval is a time domain interval between the second-stage synchronization signals.

A33: a frequency domain interval of the second-stage synchronization signals.

It should be noted that, the frequency domain interval is a frequency domain interval between the second-stage synchronization signals.

It should be noted that, a resource position of each second-stage synchronization signal may be better determined based on an indication of the configuration information, to ensure detection accuracy of the second-stage synchronization signal.

Optionally, in another embodiment of this application, the first-stage synchronization signal is jointly sent by a transmission reception point TRP cluster, and the second-stage synchronization signal is sent by at least one TRP in the TRP cluster.

It should be noted that, a TRP in each TRP cluster may support data transmission in a Coherent Joint Transmission (CJT) mode, to increase coverage of the synchronization signal. On the contrary, lower synchronization signal transmit power is required with the same coverage. In this case, compared with the first-stage synchronization signal, the second-stage synchronization signal may use a narrower beam than the first-stage synchronization signal. Resources of the first-stage synchronization signal are allocated based on the TRP cluster, so that synchronization signal extension in a network with densely dispersed TRPs is implemented without adding a new cell, thereby reducing network deployment complexity. In addition, coherent transmission of TRPs and establishment of a cooperative TRP cluster for the terminal may be better supported. The second-stage synchronization signal may use a narrower beam width, and the terminal side may detect higher RSRP and a more accurate beam direction, to improve transmission reliability.

Optionally, in another embodiment of this application, the second-stage synchronization signal is reused between different TRP clusters. It should be noted that, the case can be understood as: different first-stage synchronization signals may be associated with the same second-stage synchronization signal. In this way, search time of the second-stage synchronization signal can be further reduced.

Optionally, in another embodiment of this application, the first-stage synchronization signal and the second-stage synchronization signal meet any one of the following:

B11: a quantity of candidate positions of a synchronization raster of the first-stage synchronization signal is less than a quantity of candidate positions of the synchronization raster of the second-stage synchronization signal.

That is, the second-stage synchronization signal may use a synchronization raster (sync raster) different from that of the first-stage synchronization signal. In this way, the terminal can search for the first-stage synchronization signal more quickly, thereby reducing the search time of the synchronization signal.

B12: a frequency of the first-stage synchronization signal is different from a frequency of the second-stage synchronization signal.

For example, the first-stage synchronization signal may be deployed at a lower frequency, and the second-stage synchronization signal may be deployed at a higher frequency.

It should be noted that, a layered cell-free network can be supported in this setting manner. For example, the first-stage synchronization signal is sent by a first-layer network connected in a Single Frequency Network (SFN) manner, and the second-stage synchronization signal is sent by a second-layer network connected in a non-SFN manner. For example, the first-stage synchronization signal is sent by the first-layer network at a lower frequency, and the second-stage synchronization signal is sent by a second-layer network at a higher frequency.

B13: the first-stage synchronization signal and the second-stage synchronization signal use different synchronization signal resources.

For example, a total quantity of synchronization signals=the quantity of first-stage synchronization signals+the quantity of second-stage synchronization signals.

B14: the first-stage synchronization signal and the second-stage synchronization signal jointly indicate cell identifier information.

That is, a Cell-ID may be jointly indicated by two stages of synchronization signals. For example, the first-stage synchronization signal indicates a PSS, and the second-stage synchronization signal indicates an SSS. In this case, the terminal can determine the cell-ID only after detecting the two stages of synchronization signals.

B15: the first-stage synchronization signal and the second-stage synchronization signal separately indicate cell identifier information.

That is, a cell-ID may also be indicated in each stage of synchronization signal. For example, the PSS and the SSS are indicated in both the first-stage synchronization signal and the second-stage synchronization signal. In this case, the terminal may determine the cell-ID by detecting any stage of synchronization signal.

Optionally, in another embodiment of this application, the method further includes:

the terminal determines a preamble sequence corresponding to the second-stage synchronization signal, where

a method for determining the preamble sequence corresponding to the second-stage synchronization signal includes at least one of the following:

C11: determining the preamble sequence based on a cyclic shift of a preamble sequence of the first-stage synchronization signal.

It should be noted that, a quantity of bits of the cyclic shift used by the terminal when the terminal determines the preamble sequence corresponding to the second-stage synchronization signal may be agreed on by a protocol, pre-configured, or configured by a network-side device.

C12: determining the preamble sequence based on a mapping relationship with a preamble of the first-stage synchronization signal.

It should be noted that, a network may indicate a mapping relationship between a preamble of the second-stage synchronization signal and an associated preamble of the first-stage synchronization signal. That is, the terminal can determine, based on the mapping relationship, a specific preamble used by the second-stage synchronization signal. A specific relationship and rule may be configured by a network or a protocol. For example, a mapping relationship is shown in Table 2.

TABLE 2
Mapping table of preamble of first-stage synchronization signal and
preamble of second-stage synchronization signal

| Preamble of first-stage | Preamble set of second-stage |
|---|---|
| synchronization signal | synchronization signal |
| Preamble # 1 | Preamble # 1-1, preamble # 1-2, |
| | preamble # 1-3, and preamble # 1-4 |
| Preamble # 2 | Preamble # 2-1, preamble # 2-2, |
| | preamble # 2-3, and preamble # 2-4 |
| Preamble # 3 | Preamble # 3-1, preamble # 3-2, |
| | preamble # 3-3, and preamble # 3-4 |
| Preamble # 4 | Preamble # 4-1, preamble # 4-2, |
| | preamble # 4-3, and preamble # 4-4 |

C13: determining the preamble sequence based on a preamble sequence set of the second-stage synchronization signal configured by the network-side device.

It should be noted that, in this case, the preamble sequence of the second-stage synchronization signal is randomly determined in the preamble sequence set of the second-stage synchronization signal.

Optionally, in another embodiment of this application, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource, for example, an MIB and/or an SIB. The second resource includes: a time domain resource and/or a frequency domain resource, for example, an MIB and/or an SIB.

That is, the system message may be jointly carried or separately carried by two stages of synchronization signals, to perform more flexible information configuration.

Specifically, when the system message are jointly carried, for example, a part of the system message may be carried in each of the two stages of synchronization signals, the terminal can detect both the two synchronization signals, and can only obtain a complete system message after combining the system message of the two stages of synchronization signals, to perform random access. when the system message are separately carried, the terminal may obtain, by only the first-stage synchronization signal, a complete system message required for access. That is, the terminal may perform random access by the first-stage synchronization signal after detecting the first-stage synchronization signal, or may perform random access after sequentially detecting the first-stage synchronization signal and the second-stage synchronization signal.

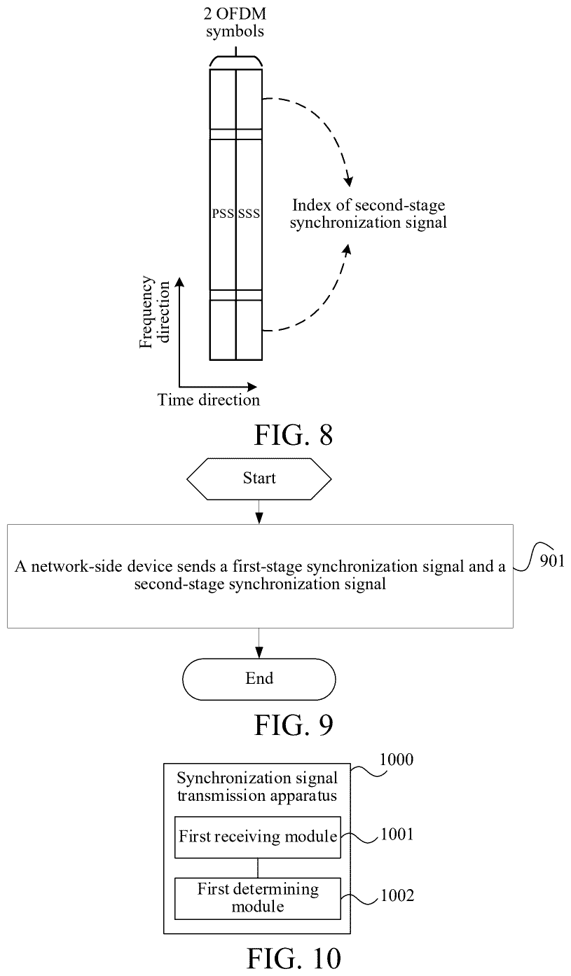

For example, all of the system message of the first-stage synchronization signal and the second-stage synchronization signal may be carried in the first-stage synchronization signal, that is, the first-stage synchronization signal is a common synchronization signal, and all of the system message of the two stages of synchronization signals may be included in the first-stage synchronization signal and/or a resource corresponding to the first-stage synchronization signal. The second-stage synchronization signal includes at least one of a PSS or an SSS. The second-stage synchronization signal is used for downlink measurement of the terminal. The second resource associated with the second-stage synchronization signal includes an index of the second-stage synchronization signal. As shown in FIG. 8, the index of the synchronization signal may be carried on two sides or one side of the PSS and/or the SSS.

The terminal may directly perform access after detecting the first-stage synchronization signal, to support some low-rate data transmission scenarios. Alternatively, access may be performed after the first-stage synchronization signal and the second-stage synchronization signal are detected.

It should be noted that, the second-stage synchronization signal includes only partial information of the PSS and/or the SSS. Resources required by the second-stage synchronization signal are reduced and change from occupying four symbols to occupying only two symbols. With same synchronization signal resources, a larger quantity of second-stage synchronization signals can be supported, and the quantity of synchronization signals can be extended.

In a structure of the two stages of synchronization signals in this embodiment of this application, the second-stage synchronization signal is associated with the first-stage synchronization signal. The system message obtained by the terminal may be dispersed in synchronization signals of different stages, or is entirely included in the first-stage synchronization signal. Therefore, the second-stage synchronization signal may not include the system message, and occupies fewer OFDM symbol resources, to extend the quantity of synchronization signals.

Optionally, in another embodiment of this application, the method further includes:
the terminal selects, based on the signal quality of the first-stage synchronization signal, a target first-stage synchronization signal with signal quality greater than or equal to a second threshold; and
the terminal sends an Msg A or an Msg 1 for random access by using a Physical Random Access Channel (PRACH) resource associated with the target first-stage synchronization signal.

Optionally, in another embodiment of this application, the method further includes:
the terminal selects, based on signal quality of the second-stage synchronization signal, a target second-stage synchronization signal with signal quality greater than or equal to a third threshold; and
the terminal sends an Msg A or an Msg 1 for random access by using a PRACH resource associated with the target second-stage synchronization signal.

It should be noted that, the terminal may determine, based on a configured threshold of the signal quality, a specific stage of synchronization signal for access; or when the first-stage synchronization signal has lower signal quality, perform measurement and random access based on the second-stage synchronization signal, to obtain a more accurate beam direction and a synchronization signal with stronger signal quality, thereby improving reliability of the random access. In this way, an interaction process of random access and uplink and downlink signaling with a lower success rate is reduced.

It should be further noted that, the first threshold, the second threshold, and the third threshold are agreed on a protocol, pre-configured, or configured by a network-side device. Values of the first threshold, the second threshold, and the third threshold may be the same or different.

It should be noted that, in an actual application, the foregoing embodiments may be separately implemented, or may be implemented in combination with each other.

It should be noted that, in at least one embodiment of this application, according to the design of the two stages of synchronization signals, synchronization signal extension in a CF network with densely deployed TRPs can be supported, including extension of a service range and a quantity of synchronization signals.

Advantages to a network side: compared with design of the same-stage synchronization signal, the network deployment complexity is simplified, and denser TRP deployment may be supported by increasing the quantity of first-stage synchronization signals without adding a new cell.

Advantages to a terminal side: the interference of synchronization signals is reduced, and the second-stage synchronization signal is measured according to a requirement, to obtain a synchronization signal with higher signal quality and a more accurate beam direction, thereby increasing a success rate and improving reliability of random access and data transmission of the terminal. In addition, more accurate beam measurement is completed during access, instead of performing CSI-RS measurement after entering a connected mode, to facilitate fast data transmission at a higher rate, especially applicable to a user having only a small amount of data transmission after access.

Corresponding to the implementation on the terminal side, as shown in FIG. 9, an embodiment of this application provides a synchronization signal transmission method, including the following steps.

Step 901: A network-side device sends a first-stage synchronization signal and a second-stage synchronization signal.

Optionally, the method further includes:
the network-side device sends indication information on a resource associated with the first-stage synchronization signal, where the indication information includes: explicit information and/or implicit information indicating a resource position of the second-stage synchronization signal; and
the explicit information includes at least one of the following:

a synchronization raster of the second-stage synchronization signal;
the frequency domain position of the second-stage synchronization signal; or the time domain position of the second-stage synchronization signal; and
the implicit information includes at least one of the following:
a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where the configuration information includes at least one of the following:
a quantity of the second-stage synchronization signals;
a time domain interval of the second-stage synchronization signals; or
a frequency domain interval of the second-stage synchronization signals.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a Transmission Reception Point (TRP) cluster, and the second-stage synchronization signal is sent by at least one TRP in the TRP cluster.

Optionally, the second-stage synchronization signal is reused between different TRP clusters.

Optionally, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and

the second-stage synchronization signal includes at least one of the following: a Primary Synchronization Signal (PSS); or

a Secondary Synchronization Signal (SSS).

Optionally, the method further includes:

the network-side device receives an Msg A or an Msg 1 by using a physical random access channel PRACH resource associated with the first-stage synchronization signal or the second-stage synchronization signal.

Optionally, after the network-side device receives the Msg A or the Msg 1 by using the physical random access channel PRACH resource associated with the first-stage synchronization signal or the second-stage synchronization signal, the method further includes:

the network-side device sends an Msg B or an Msg 2 to a terminal.

It should be noted that, all descriptions about the network-side device in the foregoing embodiments are applicable to embodiments of the synchronization signal transmission method applied to the network-side device, and the same technical effects can be achieved. Details are not described herein again.

The synchronization signal transmission method according to embodiments of this application may be performed by a synchronization signal transmission apparatus. In embodiments of this application, the synchronization signal transmission apparatus provided in embodiments of this application is described by using an example in which the synchronization signal transmission apparatus performs the synchronization signal transmission method.

As shown in FIG. 10, a synchronization signal transmission apparatus 1000 according to an embodiment of this application is used in a terminal, including:

a first receiving module 1001, configured to receive a first-stage synchronization signal sent by a network-side device; and obtain signal quality of the first-stage synchronization signal; and

a first determining module 1002, configured to determine, based on the signal quality, whether to detect a second-stage synchronization signal, where the signal quality includes at least one of the following:

Reference Signal Received Power (RSRP);

### Reference Signal Received Quality (RSRQ); or

a Signal to Interference plus Noise Ratio (SINR).

Optionally, the first determining module 1002 is configured to:

detect the second-stage synchronization signal in a case that the signal quality of the first-stage synchronization signal is less than a first threshold.

Optionally, the first determining module 1002 includes:
an obtaining unit, configured to obtain a resource position of the second-stage synchronization signal based on a resource associated with the first-stage synchronization signal, where the resource position of the second-stage synchronization signal includes: a time domain position and/or a frequency domain position; and
a detection unit, configured to detect the second-stage synchronization signal based on the resource position of the second-stage synchronization signal.

Optionally, the obtaining unit is configured to:
obtain indication information on the resource associated with the first-stage synchronization signal, where the indication information includes: explicit information and/or implicit information indicating the resource position of the second-stage synchronization signal; and
determine, based on the indication information, the resource position of the second-stage synchronization signal, where

the explicit information includes at least one of the following:
a synchronization raster of the second-stage synchronization signal;
the frequency domain position of the second-stage synchronization signal; or the time domain position of the second-stage synchronization signal; and

the implicit information includes at least one of the following:
a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where

the configuration information includes at least one of the following: a quantity of the second-stage synchronization signals;
a time domain interval of the second-stage synchronization signals; or
a frequency domain interval of the second-stage synchronization signals.

Optionally, in an implementation, in a case that the indication information includes the implicit information, determining, by the terminal based on the indication information, the resource position of the second-stage synchronization signal includes:

determining the resource position of the second-stage synchronization signal based on the indication information and a time domain position and/or a frequency domain position of the first-stage synchronization signal.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a Transmission Reception Point (TRP) cluster, and the second-stage synchronization signal is sent by at least one TRP in the TRP cluster.

Optionally, the second-stage synchronization signal is reused between different TRP clusters.

Optionally, the apparatus further includes:

a second determining module, configured to determine a preamble sequence corresponding to the second-stage synchronization signal, where

a method for determining the preamble sequence corresponding to the second-stage synchronization signal includes at least one of the following:

determining the preamble sequence based on a cyclic shift of a preamble sequence of the first-stage synchronization signal;
determining the preamble sequence based on a mapping relationship with a preamble of the first-stage synchronization signal; or
determining the preamble sequence based on a preamble sequence set of the second-stage synchronization signal configured by the network-side device.

Optionally, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and the second-stage synchronization signal includes at least one of the following:
a Primary Synchronization Signal (PSS); or
a Secondary Synchronization Signal (SSS).

Optionally, the first determining module 1002 is configured to:

skip detecting the second-stage synchronization signal in a case that the signal quality of the first-stage synchronization signal is greater than or equal to a first threshold.

Optionally, the apparatus further includes:
a first selection module, configured to select, based on the signal quality of the first-stage synchronization signal, a target first-stage synchronization signal with signal quality greater than or equal to a second threshold; and
a second sending module, configured to send an Msg A or an Msg 1 for random access by using a Physical Random Access Channel (PRACH) resource associated with the target first-stage synchronization signal.

Optionally, the apparatus further includes:

a second selection module, configured to select, based on signal quality of the second-stage synchronization signal, a target second-stage synchronization signal with signal quality greater than or equal to a third threshold; and

a third sending module, configured to send an Msg A or an Msg 1 for random access by using a PRACH resource associated with the target second-stage synchronization signal.

It should be noted that, the apparatus embodiment corresponds to the foregoing method, all the implementations in the method embodiment are applicable to the apparatus embodiment, and the same technical effects can be achieved.

The synchronization signal transmission apparatus in this embodiment of this application may be an electronic device, for example, an electronic device with an operating system, or a component in an electronic device, for example, an integrated circuit or a chip. The electronic device may be a terminal or another device other than a terminal. For example, the terminal may include, but is not limited to, the type of terminal 11 listed above, and the another device may be a server, a Network Attached Storage (NAS), or the like. This is not specifically limited in embodiments of this application.

The synchronization signal transmission apparatus according to embodiments of this application may implement all processes implemented in the method embodiment in FIG. 4, and achieve the same technical effects. Details are not described herein again to avoid repetition.

An embodiment of this application further provides a terminal, including a processor and a communication interface. The communication interface is configured to receive a first-stage synchronization signal sent by a network-side device; and obtain signal quality of the first-stage synchronization signal; and

the processor is configured to determine, based on the signal quality, whether to detect a second-stage synchronization signal, where the signal quality includes at least one of the following:

Reference Signal Received Power (RSRP);

### Reference Signal Received Quality (RSRQ); or

a Signal to Interference plus Noise Ratio (SINR).

Optionally, the processor is configured to:

detect the second-stage synchronization signal in a case that the signal quality of

the first-stage synchronization signal is less than a first threshold.

Optionally, the processor is configured to:

obtain a resource position of the second-stage synchronization signal based on a resource associated with the first-stage synchronization signal, where the resource position of the second-stage synchronization signal includes: a time domain position and/or a frequency domain position; and

detect the second-stage synchronization signal based on the resource position of the second-stage synchronization signal.

Optionally, the processor is configured to:
obtain indication information on the resource associated with the first-stage synchronization signal, where the indication information includes: explicit information and/or implicit information indicating the resource position of the second-stage synchronization signal; and
determine, based on the indication information, the resource position of the second-stage synchronization signal, where the explicit information includes at least one of the following:

a synchronization raster of the second-stage synchronization signal;
the frequency domain position of the second-stage synchronization signal; or the time domain position of the second-stage synchronization signal; and
the implicit information includes at least one of the following:

a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where the configuration information includes at least one of the following:

a quantity of the second-stage synchronization signals;
a time domain interval of the second-stage synchronization signals; or a frequency domain interval of the second-stage synchronization signals.

Optionally, in a case that the indication information includes the implicit information, the processor is configured to:

determine the resource position of the second-stage synchronization signal based on the indication information and a time domain position and/or a frequency domain position of the first-stage synchronization signal.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a Transmission Reception Point (TRP) cluster, and the second-stage synchronization signal is sent by at least one TRP in the TRP cluster.

Optionally, the second-stage synchronization signal is reused between different TRP clusters.

Optionally, the processor is further configured to:

determine a preamble sequence corresponding to the second-stage synchronization signal, where

a method for determining the preamble sequence corresponding to the second-stage synchronization signal includes at least one of the following:

determining the preamble sequence based on a cyclic shift of a preamble sequence of the first-stage synchronization signal;
determining the preamble sequence based on a mapping relationship with a preamble of the first-stage synchronization signal; or
determining the preamble sequence based on a preamble sequence set of the second-stage synchronization signal configured by the network-side device.

Optionally, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and

the second-stage synchronization signal includes at least one of the following: a Primary Synchronization Signal (PSS); or

a Secondary Synchronization Signal (SSS).

Optionally, the processor is further configured to:

skip detecting the second-stage synchronization signal in a case that the signal quality of the first-stage synchronization signal is greater than or equal to a first threshold.

Optionally, the processor is further configured to:
select, based on the signal quality of the first-stage synchronization signal, a target first-stage synchronization signal with signal quality greater than or equal to a second threshold; and
the communication interface is further configured to send an Msg A or an Msg 1 for random access by using a Physical Random Access Channel (PRACH) resource associated with the target first-stage synchronization signal.

Optionally, the processor is further configured to:
select, based on signal quality of the second-stage synchronization signal, a target second-stage synchronization signal with signal quality greater than or equal to a third threshold; and
the communication interface is further configured to send an Msg A or an Msg 1 for random access by using a PRACH resource associated with the target second-stage synchronization signal.

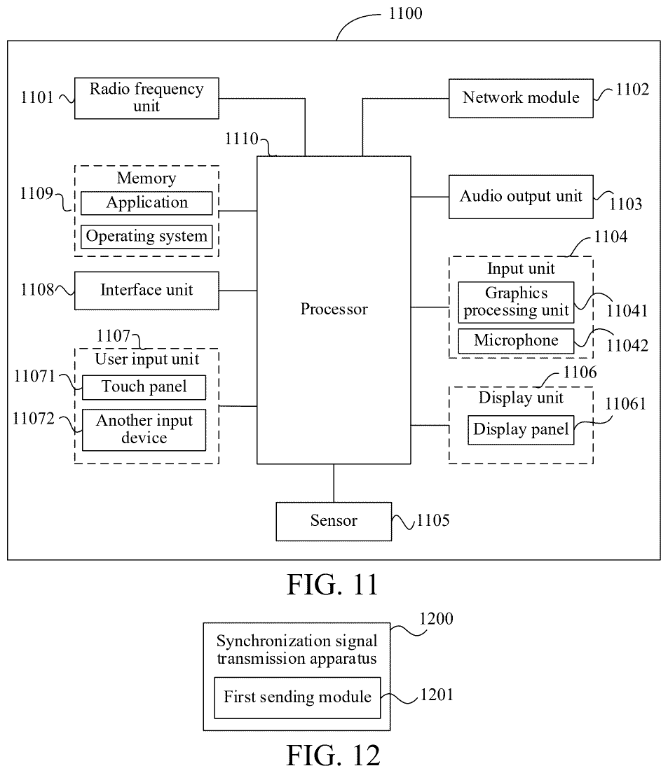

The terminal embodiment corresponds to the terminal-side method embodiment described above, and all implementation processes and implementations of the method embodiment described above may be used in the terminal embodiment, and the same technical effects can be achieved. Specifically, FIG. 11 is a diagram of a hardware structure of a terminal according to an embodiment of this application.

The terminal 1100 includes but is not limited to: at least some of components of a radio frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that, the terminal 1100 may further include a power supply (for example, a battery) for supplying power to the components. The power supply may be logically connected to the processor 1110 by using a power management system, to implement functions such as charging, discharging, and power consumption management by using the power management system. The structure of the terminal shown in FIG. 11 constitutes no limitation on the terminal. The terminal may include more or fewer components than those shown in the figure, or combine some components, or have different component arrangements. Details are not described herein again.

It should be understood that, in this embodiment of this application, the input unit 1104 may include a Graphics Processing Unit (GPU) 11041 and a microphone 11042. The graphics processing unit 11041 performs processing on image data of a static image or a video that is obtained by an image capture device (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 or another input device 11072. The touch panel 11071 is alternatively referred to as a touchscreen. The touch panel 11071 may include two parts: a touch detection apparatus and a touch controller. The another input device 11072 may include, but is not limited to, a physical keyboard, a function button (for example, a volume control button, a power button, or the like), a trackball, a mouse, and a joystick. Details are not described herein again.

In this embodiment of this application, after receiving downlink data from an access network device, the radio frequency unit 1101 may transmit the downlink data to the processor 1110 for processing. In addition, the radio frequency unit 1101 may send uplink data to a network-side device. Generally, the radio frequency unit 1101 includes, but is not limited to, an antenna, an amplifier, a transceiver, a coupler, a low noise amplifier, a duplexer, and the like.

The memory 1109 may be configured to store a software program or instructions and various data. The memory 1109 may mainly include a first storage area for storing the program and the instructions and a second storage area for storing the data. The first storage area may store an operating system, an application or instructions required by at least one function (for example, a sound playback function, an image display function, and the like), and the like. In addition, the memory 1109 may include a volatile memory or a non-volatile memory, or the memory 1109 may include both a volatile memory and a non-volatile memory. The non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). The memory 1109 in this embodiment of this application includes, but is not limited to, these memories and any memory of another proper type.

The processor 1110 may include one or more processing units. Optionally, the processor 1110 integrates an application processor and a modem processor. The application processor mainly processes an operation related to an operating system, a user interface, an application, and the like, and the modem processor mainly processes a wireless communication signal, for example, a baseband processor. It may be understood that, the modem processor may not be integrated into the processor 1110.

The radio frequency unit 1101 is configured to:
receive a first-stage synchronization signal sent by a network-side device; and
obtain signal quality of the first-stage synchronization signal; and
the processor 1110 is configured to determine, based on the signal quality, whether to detect a second-stage synchronization signal, where the signal quality includes at least one of the following:

Reference Signal Received Power (RSRP);
Reference Signal Received Quality (RSRQ); or
a Signal to Interference plus Noise Ratio (SINR).

Optionally, the processor 1110 is configured to:

detect the second-stage synchronization signal in a case that the signal quality of the first-stage synchronization signal is less than a first threshold.

Optionally, the processor 1110 is configured to:
obtain a resource position of the second-stage synchronization signal based on a resource associated with the first-stage synchronization signal, where the resource position of the second-stage synchronization signal includes: a time domain position and/or a frequency domain position; and
detect the second-stage synchronization signal based on the resource position of the second-stage synchronization signal.

Optionally, the processor 1110 is configured to:
obtain indication information on the resource associated with the first-stage synchronization signal, where the indication information includes: explicit information and/or implicit information indicating the resource position of the second-stage synchronization signal; and
determine, based on the indication information, the resource position of the second-stage synchronization signal, where

the explicit information includes at least one of the following:
a synchronization raster of the second-stage synchronization signal;
the frequency domain position of the second-stage synchronization signal; or
the time domain position of the second-stage synchronization signal; and
the implicit information includes at least one of the following:

a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where

the configuration information includes at least one of the following: a quantity of the second-stage synchronization signals;
a time domain interval of the second-stage synchronization signals; or a frequency domain interval of the second-stage synchronization signals.

Optionally, in a case that the indication information includes the implicit information, the processor is configured to:

determine the resource position of the second-stage synchronization signal based on the indication information and a time domain position and/or a frequency domain position of the first-stage synchronization signal.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a transmission reception point TRP cluster, and the second-stage synchronization signal is sent by at least one TRP in the TRP cluster.

Optionally, the second-stage synchronization signal is reused between different TRP clusters.

Optionally, the processor 1110 is further configured to:

determine a preamble sequence corresponding to the second-stage synchronization signal, where

a method for determining the preamble sequence corresponding to the second-stage synchronization signal includes at least one of the following:

determining the preamble sequence based on a cyclic shift of a preamble sequence of the first-stage synchronization signal;
determining the preamble sequence based on a mapping relationship with a preamble of the first-stage synchronization signal; or
determining the preamble sequence based on a preamble sequence set of the second-stage synchronization signal configured by the network-side device.

Optionally, a first resource associated with the first-stage synchronization signal and a second resource associated with the second-stage synchronization signal jointly carry a system message; or

a first resource associated with the first-stage synchronization signal carries a system message, where the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and

the second-stage synchronization signal includes at least one of the following: a Primary Synchronization Signal (PSS); or

a Secondary Synchronization Signal (SSS).

Optionally, the processor 1110 is further configured to:

skip detecting the second-stage synchronization signal in a case that the signal quality of the first-stage synchronization signal is greater than or equal to a first threshold.

Optionally, the processor 1110 is further configured to:
select, based on the signal quality of the first-stage synchronization signal, a target first-stage synchronization signal with signal quality greater than or equal to a second threshold; and
the radio frequency unit 1101 is further configured to send an Msg A or an Msg 1 for random access by using a physical random access channel PRACH resource associated with the target first-stage synchronization signal.

Optionally, the processor 1110 is further configured to:
select, based on signal quality of the second-stage synchronization signal, a target second-stage synchronization signal with signal quality greater than or equal to a third threshold; and
the radio frequency unit 1101 is further configured to send an Msg A or an Msg 1 for random access by using a PRACH resource associated with the target second-stage synchronization signal.

Optionally, an embodiment of this application further provides a terminal, including a processor and a memory. A program or instructions are stored in the memory and may be run on the processor. When the program or the instructions are executed by the processor, all processes of the foregoing synchronization signal transmission method in embodiments are implemented, and the same technical effects can be achieved. Details are not described herein again to avoid repetition.

An embodiment of this application further provides a readable storage medium. The computer readable storage medium stores a program or instructions, and when the program or instructions are executed by a processor, all processes of the foregoing synchronization signal transmission method in embodiments are implemented, and the same technical effects can be achieved. Details are not described herein again to avoid repetition.

The computer readable storage medium is, for example, a computer read-only memory ROM, a random access memory RAM, a magnetic disk, an optical disc, or the like.

As shown in FIG. 12, an embodiment of this application further provides a synchronization signal transmission apparatus 1200, used in a network-side device. The apparatus includes:

a first sending module 1201, configured to send a first-stage synchronization signal and a second-stage synchronization signal.

Optionally, the apparatus further includes:
a fourth sending module, configured to send indication information on a resource associated with the first-stage synchronization signal, where the indication information includes: explicit information and/or implicit information indicating a resource position of the second-stage synchronization signal; and the explicit information includes at least one of the following:

a synchronization raster of the second-stage synchronization signal;
the frequency domain position of the second-stage synchronization signal; or the time domain position of the second-stage synchronization signal; and
the implicit information includes at least one of the following:

a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where

the configuration information includes at least one of the following: a quantity of the second-stage synchronization signals;
a time domain interval of the second-stage synchronization signals; or
a frequency domain interval of the second-stage synchronization signals.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a transmission reception point TRP cluster, and the second-stage synchronization signal is sent by at least one TRP in the TRP cluster.

Optionally, the second-stage synchronization signal is reused between different TRP clusters.

Optionally, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and

the second-stage synchronization signal includes at least one of the following:

a Primary Synchronization Signal (PSS); or

a Secondary Synchronization Signal (SSS).

Optionally, the apparatus further includes:

a second receiving module, configured to receive an Msg A or an Msg 1 by using a Physical Random Access Channel (PRACH) resource associated with the first-stage synchronization signal or the second-stage synchronization signal.

Optionally, the apparatus further includes:

a fifth sending module, configured to send an Msg B or an Msg 2 to a terminal.

It should be noted that, the apparatus embodiment shows an apparatus corresponding to the foregoing method, all the implementations in the method embodiment are applicable to the apparatus embodiment, and the same technical effects can be achieved. Details are not described herein again.

An embodiment of this application further provides a network-side device, including a processor and a communication interface. The communication interface is configured to send a first-stage synchronization signal and a second-stage synchronization signal.

Optionally, the communication interface is further configured to:
send indication information on a resource associated with the first-stage synchronization signal, where the indication information includes: explicit information and/or implicit information indicating a resource position of the second-stage synchronization signal; and the explicit information includes at least one of the following:

a synchronization raster of the second-stage synchronization signal;
the frequency domain position of the second-stage synchronization signal; or the time domain position of the second-stage synchronization signal; and
the implicit information includes at least one of the following:

a time domain offset and/or a frequency domain offset of the second-stage synchronization signal relative to the first-stage synchronization signal; or
a mapping relationship between an index set of the first-stage synchronization signal and an index set of the second-stage synchronization signal.

Optionally, the indication information further includes: configuration information, where the configuration information includes at least one of the following:

a quantity of the second-stage synchronization signals;
a time domain interval of the second-stage synchronization signals; or
a frequency domain interval of the second-stage synchronization signals.

Optionally, the first-stage synchronization signal and the second-stage synchronization signal meet any one of the following:
a quantity of candidate positions of a synchronization raster of the first-stage synchronization signal is less than a quantity of candidate positions of the synchronization raster of the second-stage synchronization signal;
a frequency of the first-stage synchronization signal is different from a frequency of the second-stage synchronization signal;
the first-stage synchronization signal and the second-stage synchronization signal use different synchronization signal resources;
the first-stage synchronization signal and the second-stage synchronization signal jointly indicate cell identifier information; or
the first-stage synchronization signal and the second-stage synchronization signal separately indicate cell identifier information.

Optionally, the first-stage synchronization signal is jointly sent by a transmission reception point TRP cluster, and the second-stage synchronization signal is sent by at least one TRP in the TRP cluster.

Optionally, the second-stage synchronization signal is reused between different TRP clusters.

Optionally, a first resource associated with the first-stage synchronization signal and a second resource associated with the second-stage synchronization signal jointly carry a system message; or

a first resource associated with the first-stage synchronization signal carries a system message, where

the first resource includes: a time domain resource and/or a frequency domain resource; and the second resource includes: a time domain resource and/or a frequency domain resource.

Optionally, in a case that the first resource associated with the first-stage synchronization signal carries the system message, the second resource associated with the second-stage synchronization signal includes an index of the second-stage synchronization signal; and

the second-stage synchronization signal includes at least one of the following: a Primary Synchronization Signal (PSS); or

a Secondary Synchronization Signal (SSS).

Optionally, the communication interface is further configured to:

receive an Msg A or an Msg 1 by using a physical random access channel PRACH resource associated with the first-stage synchronization signal or the second-stage synchronization signal.

Optionally, after the communication interface receives the Msg A or the Msg 1 by using the physical random access channel PRACH resource associated with the first-stage synchronization signal or the second-stage synchronization signal, the communication interface is further configured to:

send an Msg B or an Msg 2 to a terminal.

Optionally, an embodiment of this application further provides a network-side device, including a processor and a memory. A program or instructions are stored in the memory and may be run on the processor. When the program or the instructions are executed by the processor, all processes of the foregoing synchronization signal transmission method in embodiments are implemented, and the same technical effects can be achieved. Details are not described herein again to avoid repetition.

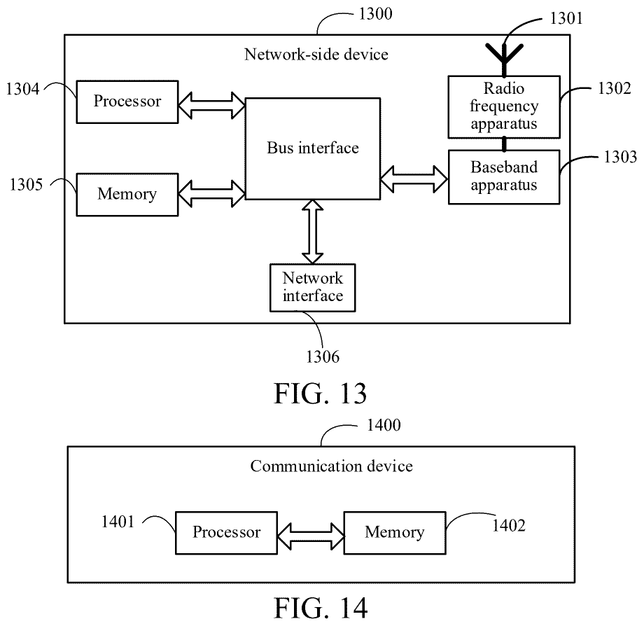

Specifically, an embodiment of this application further provides a network-side device. As shown in FIG. 13, the network-side device 1300 includes: an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information through the antenna 1301 and sends the received information to the baseband apparatus 1303 for processing. In a downlink direction, the baseband apparatus 1303 processes to-be-sent information and sends the information to the radio frequency apparatus 1302, and the radio frequency apparatus 1302 processes the received information and sends the information through the antenna 1301.

The method performed by the access network device in the foregoing embodiment may be implemented in the baseband apparatus 1303. The baseband apparatus 1303 includes a baseband processor.

The baseband apparatus 1303 may include, for example, at least one baseband board, and a plurality of chips are disposed on the baseband board. As shown in FIG. 13, one of the chips is, for example, the baseband processor, connected to the memory 1305 through a bus interface, to invoke a program in the memory 1305, and perform an operation performed by the network device shown in the foregoing method embodiment.

The access network device may further include a network interface 1306, and the interface is, for example, a Common Public Radio Interface (CPRI).

Specifically, the network-side device 1300 in this embodiment of this application further includes: instructions or a program stored in the memory 1305 and run on the processor 1304. The processor 1304 invokes the instructions or the program in the memory 1305, to perform the methods performed by the modules shown in FIG. 12, and same technical effects are achieved. Details are not described herein again to avoid repetition.

An embodiment of this application further provides a readable storage medium.

The readable storage medium stores a program or instructions, and when the program or the instructions are executed by a processor, all processes of the synchronization signal transmission method in embodiments are implemented and the same technical effects can be achieved. Details are not described herein again to avoid repetition.

The processor is a processor in the access network device in the foregoing embodiment. The readable storage medium includes a computer-readable storage medium, for example, a computer read-only memory ROM, a random access memory RAM, a magnetic or an optical disc, and the like.

Optionally, as shown in FIG. 14, an embodiment of this application further provides a communication device 1400, including a processor 1401 and a memory 1402. The memory 1402 stores a program and instructions that can be run on the processor 1401. For example, when the communication device 1400 is a terminal, and when the program or the instructions are executed by the processor 1401, all steps of the synchronization signal transmission method in embodiments are implemented, and the same technical effects can be achieved. When the communication device 1400 is a network-side device, and when the program or the instructions are executed by the processor 1401, all steps of the synchronization signal transmission method in embodiments are implemented, and the same technical effects can be achieved. Details are not described herein again to avoid repetition.

An embodiment of this application further provides a chip. The chip includes a processor and a communication interface. The communication interface is coupled to the processor, and the processor is configured to run a program or instructions, to implement all processes of the synchronization signal transmission method in embodiments, and the same technical effects can be achieved. Details are not described herein again to avoid repetition.

It should be understood that, the chip in this embodiment of this application may alternatively be referred to as a system-level chip, a system chip, a chip system, a system-on-chip, or the like.

An embodiment of this application further provides a computer program/program product. The computer program/program product is stored in a storage medium. The computer program/program product is executed by at least one processor, to implement all processes of the synchronization signal transmission method in embodiments, and the same technical effects can be achieved. Details are not described herein again to avoid repetition.

An embodiment of this application further provides a synchronization signal transmission system, including: a terminal and a network-side device, where the terminal may be configured to perform steps of the synchronization signal transmission method, and the network-side device may be configured to perform steps of the synchronization signal transmission method.

It should be noted that, the terms “include”, “comprise”, or any other variation thereof in this specification is intended to cover a non-exclusive inclusion, so that a process, a method, an article, or an apparatus that includes a list of elements not only includes those elements but also includes other elements that are not expressly listed, or further includes elements inherent to such a process, a method, an article, or an apparatus. An element preceded by “includes a” does not, without more constraints, preclude the presence of additional identical elements in the process, the method, the article, or the apparatus that includes the element. In addition, it should be noted that, scopes of the method and the apparatus in the implementations of this application are not limited to performing functions in an order shown or discussed, but may include performing functions in a substantially concurrent manner or in reverse order depending on functionality involved. For example, the methods described may be performed in an order different from that described, and various steps may alternatively be added, omitted, or combined. In addition, features described with reference to some examples may alternatively be combined in another example.

According to the descriptions of the foregoing implementations, a person skilled in the art may clearly understand that the method according to the foregoing embodiment may be implemented by software in addition to necessary universal hardware platform, or by using hardware. In many cases, the former is a better implementation. Based on such an understanding, the technical solutions of this application essentially or the part contributing to the conventional technology may be implemented in a form of a computer software product. The computer software product is stored in a storage medium (such as a ROM/RAM, a magnetic disk, or an optical disc) and includes several indications for instructing a terminal (which may be a mobile phone, a computer, a server, an air conditioner, a network device, or the like) to perform the methods described in embodiments of this application.

Embodiments of this application are described with reference to the accompanying drawings. This application is not limited to the specific implementations described above, and the specific implementations described above are merely examples and not limited. A person of ordinary skill in the art may also make various variations under the inspiration of this application and without departing from the purpose of this application and the protection scope of the claims, and such variations shall all fall within the protection scope of this application.

What is claimed is:

1. A synchronization signal transmission method, comprising:
receiving, by a terminal, a first synchronization signal sent by a network-side device; and obtaining signal quality of the first synchronization signal; and
determining, by the terminal based on the signal quality, whether to detect a second synchronization signal, wherein
the signal quality comprises at least one of the following:
Reference Signal Received Power (RSRP);
Reference Signal Received Quality (RSRQ); or
a Signal to Interference plus Noise Ratio (SINR).

2. The method according to claim 1, wherein determining, by the terminal based on the signal quality, whether to detect the second synchronization signal comprises:
detecting, by the terminal, the second synchronization signal in response to the signal quality of the first synchronization signal being less than a first threshold.

3. The method according to claim 2, wherein detecting the second synchronization signal comprises:
obtaining, by the terminal, a resource position of the second synchronization signal based on a resource associated with the first synchronization signal, wherein the resource position of the second synchronization signal comprises: at least one of a time domain position or a frequency domain position; and
detecting the second synchronization signal based on the resource position of the second synchronization signal.

4. The method according to claim 3, wherein obtaining, by the terminal, the resource position of the second synchronization signal based on the resource associated with the first synchronization signal comprises:
obtaining, by the terminal, indication information on the resource associated with the first synchronization signal, wherein the indication information comprises: at least one of explicit information or implicit information indicating the resource position of the second synchronization signal; and
determining, by the terminal based on the indication information, the resource position of the second synchronization signal, wherein
the explicit information comprises at least one of the following:
a synchronization raster of the second synchronization signal;
the frequency domain position of the second synchronization signal; or
the time domain position of the second synchronization signal; and
the implicit information comprises at least one of the following:
at least one of a time domain offset or a frequency domain offset of the second synchronization signal relative to the first synchronization signal; or
a mapping relationship between an index set of the first synchronization signal and an index set of the second synchronization signal.

5. The method according to claim 4, wherein the indication information further comprises: configuration information, wherein
the configuration information comprises at least one of the following:
a quantity of the second synchronization signals;
a time domain interval of the second synchronization signals; or
a frequency domain interval of the second synchronization signals.

6. The method according to claim 4, wherein in response to the indication information comprising the implicit information, determining, by the terminal based on the indication information, the resource position of the second synchronization signal comprises:
determining, by the terminal, the resource position of the second synchronization signal based on the indication information and at least one of a time domain position or a frequency domain position of the first synchronization signal.

7. The method according to claim 1, wherein the first synchronization signal and the second synchronization signal meet any one of the following:
a quantity of candidate positions of a synchronization raster of the first synchronization signal is less than a quantity of candidate positions of the synchronization raster of the second synchronization signal;
a frequency of the first synchronization signal is different from a frequency of the second synchronization signal;
the first synchronization signal and the second synchronization signal use different synchronization signal resources;
the first synchronization signal and the second synchronization signal jointly indicate cell identifier information; or
the first synchronization signal and the second synchronization signal separately indicate cell identifier information.

8. The method according to claim 1, wherein the first synchronization signal is jointly sent by a Transmission Reception Point (TRP) cluster, and the second synchronization signal is sent by at least one TRP in the TRP cluster; or
wherein the second synchronization signal is reused between different TRP clusters.

9. The method according to claim 1, further comprising:
determining, by the terminal, a preamble sequence corresponding to the second synchronization signal, wherein
a method for determining the preamble sequence corresponding to the second synchronization signal comprises at least one of the following:
determining the preamble sequence based on a cyclic shift of a preamble sequence of the first synchronization signal;
determining the preamble sequence based on a mapping relationship with a preamble of the first synchronization signal; or
determining the preamble sequence based on a preamble sequence set of the second synchronization signal configured by the network-side device.

10. The method according to claim 1, wherein a first resource associated with the first synchronization signal and a second resource associated with the second synchronization signal jointly carry a system message; or
a first resource associated with the first synchronization signal carries a system message, wherein
the first resource comprises: at least one of a time domain resource or a frequency domain resource; and the second resource comprises: at least one of a time domain resource or a frequency domain resource.

11. The method according to claim 10, wherein in response to the first resource associated with the first synchronization signal carrying the system message, the second resource associated with the second synchronization signal comprises an index of the second synchronization signal; and
the second synchronization signal comprises at least one of the following:
a Primary Synchronization Signal (PSS); or
a Secondary Synchronization Signal (SSS).

12. The method according to claim 1, wherein determining, by the terminal based on the signal quality, whether to detect the second synchronization signal comprises:
skipping, by the terminal, detecting the second synchronization signal in response to the signal quality of the first synchronization signal being greater than or equal to a first threshold.

13. The method according to claim 1, further comprising:
selecting, by the terminal based on the signal quality of the first synchronization signal, a target first synchronization signal with signal quality greater than or equal to a second threshold; and
sending, by the terminal, an Msg A or an Msg 1 for random access by using a Physical Random Access Channel (PRACH) resource associated with the target first synchronization signal.

14. The method according to claim 2, further comprising:
selecting, by the terminal based on signal quality of the second synchronization signal, a target second synchronization signal with signal quality greater than or equal to a third threshold; and
sending, by the terminal, an Msg A or an Msg 1 for random access by using a PRACH resource associated with the target second synchronization signal.

15. A synchronization signal transmission method, comprising:
sending, by a network-side device, a first synchronization signal and a second synchronization signal.

16. The method according to claim 15, further comprising:
sending, by the network-side device, indication information on a resource associated with the first synchronization signal, wherein the indication information comprises: at least one of explicit information or implicit information indicating a resource position of the second synchronization signal; and
the explicit information comprises at least one of the following:
a synchronization raster of the second synchronization signal;
the frequency domain position of the second synchronization signal; or
the time domain position of the second synchronization signal; and
the implicit information comprises at least one of the following:
at least one of a time domain offset or a frequency domain offset of the second synchronization signal relative to the first synchronization signal; or
a mapping relationship between an index set of the first synchronization signal and an index set of the second synchronization signal.

17. The method according to claim 16, wherein the indication information further comprises: configuration information, wherein
the configuration information comprises at least one of the following:
a quantity of the second synchronization signals;
a time domain interval of the second synchronization signals; or
a frequency domain interval of the second synchronization signals.

18. The method according to claim 15, further comprising:
receiving, by the network-side device, an Msg A or an Msg 1 by using a Physical Random Access Channel (PRACH) resource associated with the first synchronization signal or the second synchronization signal.

19. The method according to claim 18, wherein after receiving, by the network-side device, the Msg A or the Msg 1 by using the PRACH resource associated with the first synchronization signal or the second synchronization signal, the method further comprises:
sending, by the network-side device, an Msg B or an Msg 2 to a terminal.

20. A terminal, comprising at least one hardware processor and a memory, wherein the memory stores a program or instructions executable by the at least one hardware processor, and when the program or the instructions are executed by the at least one hardware processor, the terminal is directed to:
receive a first synchronization signal sent by a network-side device; and obtaining signal quality of the first synchronization signal; and
determine, based on the signal quality, whether to detect a second synchronization signal, wherein the signal quality comprises at least one of the following:
Reference Signal Received Power (RSRP);
Reference Signal Received Quality (RSRQ); or
a Signal to Interference plus Noise Ratio (SINR).
